(19) United States
(12) Patent Application Publication
(10) Pub. No.: US 2024/0382982 A1
(43) Pub. Date: Nov. 21, 2024

(54) NOZZLE SYSTEM

(71) Applicants: HYUNDAI MOTOR COMPANY, Seoul (KR); KIA CORPORATION, Seoul (KR); NIFCO KOREA INC., Asan-si (KR); DY AUTO CORPORATION, Asan-si (KR)

(72) Inventors: Kyung Hwan Kim, Seoul (KR); Nak Kyoung Kong, Seongnam-si (KR); Dong Eun Cha, Hwaseong-si (KR); Sang Heon Wang, Hwaseong-si (KR); Jae Hyoung Kim, Asan-si (KR); Jong Wook Lee, Asan-si (KR); Gyu Seon Lee, Asan-si (KR)

(73) Assignees: HYUNDAI MOTOR COMPANY, Seoul (KR); KIA CORPORATION, Seoul (KR); NIFCO KOREA INC., Asan-si (KR); DY AUTO CORPORATION, Asan-si (KR)

(21) Appl. No.: 18/373,015

(22) Filed: Sep. 26, 2023

(30) Foreign Application Priority Data
May 16, 2023 (KR) 10-2023-0063195

(51) Int. Cl. B05B 1/34; B05B 1/30

(52) U.S. Cl. CPC B05B 1/34; B05B 1/3086

(57) ABSTRACT

A nozzle system includes a head part having a spray part formed at a location corresponding to a sensor part and a body part having a portion of the head part inserted thereinto and located therein. The body part includes an inlet part configured to allow fluid to flow into the body part therethrough. The nozzle system includes a delay part insertable into at least the portion of the head part and located in the body part. The delay part protrudes in a movement direction of the head part. The fluid flows into the body part and the head part is moved along the delay part and the fluid is sprayed out of the spray part of the head part when the head part is located at and clear of an end of the delay part.

### CROSS-REFERENCE TO RELATED APPLICATION

This application claims, under 35 U.S.C. § 119 (a), the benefit of priority to Korean Patent Application No. 10-2023-0063195, filed on May 16, 2023, the entire contents of which are incorporated herein by reference.

### BACKGROUND

### (a) Technical Field

The present disclosure relates to a nozzle system. More particularly, the present disclosure relates to a nozzle system configured to control a spray timing of the nozzle system located in various sensor parts and to provide various spray angles of fluid sprayed from the nozzle system.

### (b) Background Art

When it comes to spraying fluid to clean vehicle glass, particularly windshields or the like, two common methods are the jet type and the spray type. In the case of the jet type, a spray angle of fluid may be controlled by adjusting a ball located within a nozzle housing having a nozzle mounted therein. Consequently, after the washer nozzle device is manufactured, the spray angle of fluid may be appropriately adjusted through the ball.

With the recent emergence of autonomous vehicles, it is necessary to clean various sensor parts mounted on the autonomous vehicle. These sensors are configured to serve as essential components for vehicle driving. Additionally, in order to clean various sensor parts, it is necessary to provide a nozzle system configured to spray fluid to each sensor part and a location adjacent thereto.

Furthermore, in the case of the nozzle system being positioned adjacent to various sensor parts, certain challenges arise. It takes a certain amount of time to move a nozzle to an area facing the sensor part and adjusting the spray angle of the fluid may need to be set differently for each type of sensor part.

The above information disclosed in this Background section is only to enhance understanding of the background of the disclosure. Therefore, the background section may contain information that does not form the prior art that is already known in this country to a person of ordinary skill in the art.

### SUMMARY

The present disclosure has been made in an effort to solve the above-described problems associated with the prior art. Accordingly, in view of the foregoing, an effort has been made to delay spraying fluid from the nozzle system and to appropriately change the spray angle of fluid. It is an object of the present disclosure to provide a nozzle system configured to prevent fluid from being sprayed during a delay time when a discharge port of a head part is being moved to an area facing a sensor part.

In addition, another object of the present disclosure is to provide a nozzle system including a discharge port configured to have various spray angles.

The objects of the present disclosure are not limited to the above-mentioned objects. Other technical objects not mentioned herein should be more clearly understood by those having ordinary skill in the art from the detailed description of the embodiments. Further, the objects of the present disclosure may be realized by means indicated in the claims and a combination thereof.

In one aspect, the present disclosure provides a nozzle system including a head part having a spray part formed at a location corresponding to a sensor part. The nozzle system also includes a body part having a portion of the head part inserted thereinto and located therein. The body part includes an inlet part configured to allow fluid to flow into the body part therethrough. The nozzle system also includes a delay part configured to be inserted into at least the portion of the head part and located in the body part. The delay part protrudes in a movement direction of the head part. The fluid flows into the body part and the head part is moved along the delay part. The fluid may be sprayed out of the spray part of the head part when the head part is located at an end of the delay part.

In an embodiment, the nozzle system may further include an elastic member located between the body part and the head part.

In another embodiment, the head part may include a guide groove formed at a location facing the delay part. The head part may also include an inflow part formed at one end of the guide groove, wherein the one end faces the body part. The inflow part is configured to allow the fluid located in the body part to flow into the head part. The head part may also include a sealing part that surrounds one end of the head part.

In still another embodiment, the inflow part may form a cross-section wider than a cross-section of the guide groove.

In yet another embodiment, the head part may be moved by hydraulic pressure of the fluid flowing into the body part in a longitudinal direction thereof along an inside of the body part. The fluid located in the body part may flow into the head part when the head part is moved to a location at which the inflow part faces the end of the delay part.

In still yet another embodiment, the body part may further include a cover part formed at one end thereof. The head part may be operated on a side of the one end of the body part.

In a further embodiment, the spray part may be located at an end of the head part and may have a predetermined angle so as to allow the fluid flowing into the spray part to be sprayed to the sensor part.

In another further embodiment, the spray part may include a guide part configured to allow the fluid flowing into the head part to flow thereinto, and a discharge port configured to discharge the fluid flowing into the guide part.

In still another further embodiment, the discharge port may include a first discharge port formed at a relatively high location in a height direction of the spray part. The discharge port may also include a second discharge port formed at a location below the location of the first discharge port.

In yet another further embodiment, an angle formed by the first discharge port and a width direction of the head part may be smaller than an angle formed by the second discharge port and the width direction of the head part.

In another aspect, the present disclosure provides a nozzle system. The nozzle system includes a head part disposed at a location corresponding to a sensor part. The nozzle system also includes a body part having a portion of the head part inserted thereinto and located therein. The body part includes an inlet part configured to allow fluid to flow into the body part therethrough. The nozzle system also includes a delay part configured to be inserted into at least the portion of the head part and located in the body part. The delay part protrudes in a movement direction of the head part. The fluid flows into the body part and the head part is moved along the delay part. The fluid is sprayed out of the head part when the head part is located at an end of the delay part.

In an embodiment, the nozzle system may further include an elastic member located between the body part and the head part.

In another embodiment, the head part may include a guide groove formed at a location facing the delay part. The head part may include an inflow part formed at one end of the guide groove, wherein the one end faces the body part. The inflow part may be configured to allow the fluid located in the body part to flow into the head part. The head part may also include a sealing part that surrounds one end of the head part.

In still another embodiment, the inflow part may form a cross-section wider than a cross-section of the guide groove.

In yet another embodiment, the head part may be moved by hydraulic pressure of the fluid flowing into the body part in a longitudinal direction thereof along an inside of the body part. The fluid located in the body part may flow into the head part when the head part is moved to a location at which the inflow part faces the end of the delay part.

In still yet another embodiment, the body part may further include a cover part formed at one end thereof, and the head part may be operated on a side of the one end.

In a further embodiment, the head part may include a spray part formed at a location facing the sensor part.

In another further embodiment, the spray part may include a guide part configured to allow the fluid flowing into the head part to flow thereinto. The spray part may also include a discharge port configured to discharge the fluid flowing into the guide part.

In still another further embodiment, the discharge port may include a first discharge port formed at a relatively high location in a height direction of the spray part. The discharge port may also include a second discharge port formed at a location lower than the location of the first discharge port.

In yet another further embodiment, an angle formed by the first discharge port and a width direction of the head part may be smaller than an angle formed by the second discharge port and the width direction of the head part.

Other aspects and embodiments of the disclosure are discussed below.

It should be understood that the terms “vehicle,” “vehicular,” and other similar terms as used herein are inclusive of motor vehicles in general. Such motor vehicles may include sport utility vehicles (SUVs), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, e.g., a vehicle powered by both gasoline and electricity.

The above and other features of the disclosure are discussed below.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIG. 1A is a diagram showing a nozzle system disposed at a location facing a sensor part according to an embodiment of the present disclosure;

FIG. 1B is a diagram showing the nozzle system moved to a location adjacent to the front surface of the sensor part according to the embodiment of the present disclosure;

FIG. 2A is an exploded view showing a configuration of the nozzle system according to the embodiment of the present disclosure;

FIG. 2B is a diagram showing a sealing part located between a body part and a head part according to the embodiment of the present disclosure;

FIG. 3A is a cross-sectional view showing a coupling relationship of the nozzle system before operation according to the embodiment of the present disclosure;

FIG. 3B is a cross-sectional view showing a coupling relationship of the nozzle system at the time when fluid is sprayed through a discharge port according to the embodiment of the present disclosure;

FIG. 3C is a cross-sectional view showing a coupling relationship of the nozzle system in the maximally operated state according to the embodiment of the present disclosure; and

FIG. 4 is a diagram showing two different discharge ports located in a head part of the nozzle system according to the embodiment of the present disclosure.

It should be understood that the appended drawings are not necessarily drawn to scale, and thus present a somewhat simplified representation of various features illustrative of the basic principles of the disclosure. The specific design features of the present disclosure as described herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference is made in detail to various embodiments of the present disclosure, examples of which are illustrated in the accompanying drawings and described below. While the technical concepts of the disclosure are described in conjunction with embodiments, it should be understood that the present description is not intended to limit the disclosure to the embodiments. On the contrary, the disclosure is intended to cover not only the disclosed embodiments, but also various alternatives, modifications, equivalents, and other embodiments, which may be included within the spirit and scope of the disclosure as defined by the appended claims.

In addition, terms such as “part,” “port,” and “system” described in the specification mean a unit that performs at least one function or operation. The function or operation may be implemented in hardware or software or a combination of hardware and software.

Additionally, the terms in the specification are used merely to describe embodiments and are not intended to limit the present disclosure. In this specification, an expression in a singular form also includes a plural form, unless clearly specified otherwise in context.

In the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

Hereinafter, embodiments are described in detail with reference to the accompanying drawings. In the following description with reference to the accompanying drawings, the same reference numerals represent the same or corresponding components throughout the specification, and redundant descriptions thereof have been omitted.

When a component is referred to as being “connected” to or “in contact” with another component, it should be understood that it may be directly connected to or in contact with the other component, but other components may exist therebetween. On the other hand, when a component is referred to as being “directly connected” to or “directly in contact” with another component, it should be understood that there is no other component therebetween. When a component, device, element, or the like of the present disclosure is described as having a purpose or performing an operation, function, or the like, the component, device, element, or the like should be considered herein as being “configured to” meet that purpose or to perform that operation or function. Also, a component, device, element, and the like may separately embody or be included with a processor and a memory, such as a non-transitory computer readable media, as a part thereof.

The present disclosure relates to a nozzle system 10 formed at a location corresponding to various sensor parts 20 located in a vehicle performing autonomous driving. The sensor part 20 of the present disclosure may include a radar sensor, a light detection and ranging (LiDAR) sensor, a camera, an infrared sensor, a radio frequency (RF) sensor, or the like. The nozzle system 10 includes a head part 100 and a body part 200. The nozzle system 10 may be located adjacent to the disclosed sensor part 20. The head part 100 is formed to protrude toward an area facing the sensor part 20 and is configured to spray fluid onto the sensor part 20.

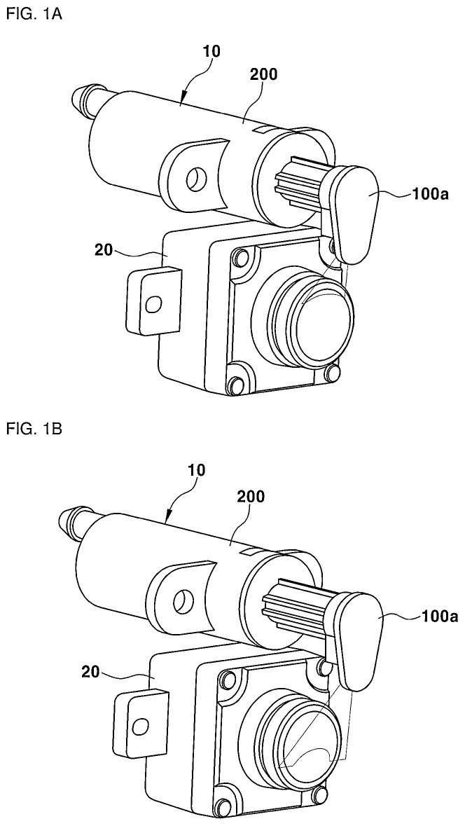

FIGS. 1A and 1B show a driving relationship of the nozzle system 10 according to an embodiment of the present disclosure.

The nozzle system 10 is located adjacent to the sensor part 20 and is configured to be fluidly connected to a reservoir (not shown) located in a vehicle body. More particularly, a first end of the body part 200 includes an inlet part 220 configured to allow fluid flowing from the reservoir to flow therethrough. As mentioned above, the nozzle system 10 includes the head part 100, which is located at a second end of the body part 200 and formed to protrude therefrom along the inside of the body part 200. The head part 100 includes a lower portion or first portion 100a and an upper portion or second portion 100b. A cover part 300 is located at the second end of the body part 200 where an end of the upper portion 100b is located. An elastic member 400 is provided between the cover part 300 and the body part 200 so that the elastic member 400 (e.g., a spring or the like) is compressed (e.g., pressed) when the head part 100 is operated.

The head part 100 is located adjacent to the sensor part 20 and is operated so as to face a sensing area of the sensor part 20 by hydraulic pressure of the fluid flowing into the body part 200. More particularly, a spray part (e.g., injection part) 140 of the head part 100 may be located to face the sensing area of the sensor part 20.

The body part 200 may be coupled to and fixed to the side of the vehicle body or the sensor part 20. Further, the body part 200 is configured so that fluid flows from the reservoir to the inside of the body part 200 through a conduit (e.g., channel, passage, or the like). An end of the lower portion 100a of the head part 100 is configured to surround a delay part 210 formed to protrude in the longitudinal direction thereof in the body part 200. The head part 100 is configured to move in the protruding direction of the delay part 210 by hydraulic pressure of the fluid flowing into the body part 200. More particularly, when the lower portion 100a of the head part 100 is moved along the delay part 210, the outer circumferential surface of the delay part 210 and the inner circumferential surface of the lower portion 100a of the head part 100 are in tight contact with each other so as to be sealed such that fluid does not flow into the head part 100.

As shown in FIG. 1B, when fluid flows into the body part 200, at least a portion of the head part 100 (e.g., the upper portion 100b) is configured to protrude toward the outermost side in the longitudinal direction of the body part 200. Additionally, fluid is discharged (e.g., sprayed) onto the sensing area of the sensor part 20 through the spray part 140 located in the upper portion 100b of the head part 100.

The spray part 140 is provided in the upper portion 100b of the head part 100 and is formed to protrude toward the sensing area of the sensor part 20. The spray part 140 includes two or more discharge ports having different spray angles. More particularly, in the embodiment of the present disclosure, the spray part 140 includes a first discharge port 142a formed at a relatively high location of the spray part 140, and a second discharge port 142b formed at a location below the position of the first discharge port 142a. The first discharge port 142a and the second discharge port 142b may be configured to have different fluid spray angles. An angle formed by the first discharge port 142a and the width direction of the head part 100 may be configured to be smaller than an angle formed by the second discharge port 142b and the width direction of the head part 100.

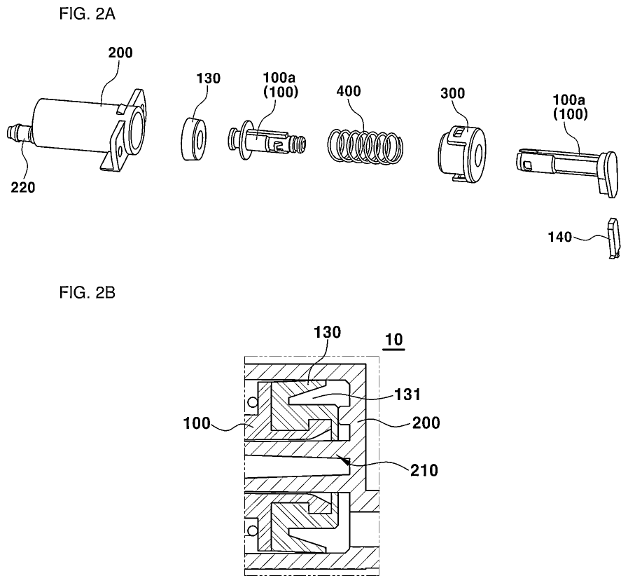

FIG. 2A is a diagram showing a detailed configuration of the nozzle system 10 of the present disclosure. FIG. 2B is a diagram showing a sealing part 130 formed between the head part 100 of the nozzle system 10 and the body part 200 thereof.

The nozzle system 10 includes the cylindrical body part 200 fixed to the sensor part 20 or the vehicle body. The nozzle system 10 also includes the delay part 210 located at the first end of the body part 200, located in the body part 200, and formed to protrude in the length direction thereof. The head part 100 is located inside the body part 200 and is located to surround the delay part 210. More particularly, the lower portion 100a of the head part 100 surrounds the delay part 210 and may move along the delay part 210 in the same direction as the protruding direction of the delay part 210.

The head part 100 of the present disclosure includes a guide groove 110 formed at a location facing the delay part 210 so that the delay part 210 is insertable into the guide groove 110. Furthermore, the head part 100 includes an inflow part 120 formed at one end of the guide groove 110. The one end of the guide groove 110 faces the body part 200, so that fluid located in the body part 200 flows into the head part 100. The inflow part 120 is formed to have a wider cross-section than the cross-section of the guide groove 110. When the head part 100 is moved to the end of the delay part 210, the fluid located in the body part 200 is discharged to the injection part 140 along the head part 100 where the inflow part 120 is adjacent to the end of the delay part 210.

The nozzle system 10 includes the cover part 300 located at the second end of the body part 200. The nozzle system 10 also includes the elastic member 400 located between the inside of the cover part 300 and the head part 100. The elastic member 400 is configured to be compressed in response to movement of the head part 100. When no fluid is flowing into the body part 200, the elastic member 400 provides elastic force so that the head part 100 is moved to the first end of the body part 200 inside the body part 200.

The upper portion 100b of the head part 100 includes the spray part 140 located in a direction corresponding to the sensing area of the sensor part 20. The spray part 140 includes a guide part 141 configured to allow (e.g., guide) fluid flowing into the head part 100 to be moved therethrough. The spray part 140 also includes a discharge port fluidly connected to the guide part 141 and configured to spray fluid to the sensing area of the sensor part 20. The discharge port is formed of at least two or more ports and the ports may be configured to have different spray angles.

As shown in FIG. 2B, the nozzle system 10 includes the sealing part 130 formed to be integrated with the head part 100 and located at the first end of the body part 200 including the delay part 210. The sealing part 130 is fixed to the head part 100 and is movable integrally with the head part 100. More particular, the sealing part 130 is fixed to the lower portion 100a of the head part 100. The sealing part 130 may include a recessed portion 131 configured to allow fluid flowing through the inlet part 220 to provide pressure to the rear surface of the sealing part 130.

The sealing part 130 may be configured to integrally surround the delay part 210. When the head part 100 performs longitudinal movement along the delay part 210, the sealing part 130 may perform a similar function to an O-ring so as to prevent fluid located in the body part 200 from flowing into a cavity between the head part 100 and the body part 200 where the elastic member 400 is located.

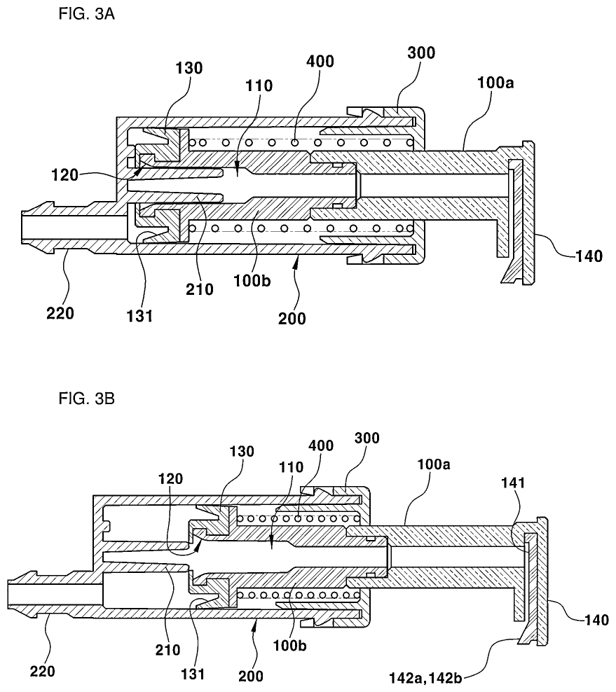

FIG. 3A shows, as an embodiment of the present disclosure, a driving relationship of the nozzle system 10 where fluid does not flow into the body part 200 or sufficient fluid does not enter, resulting in no movement of the head part 100.

As shown in FIG. 3A, the body part 200 includes the delay part 210 therein, and the head part 100 is located to surround the delay part 210. More particularly, an end of the head part 100 is configured to allow the delay part 210 to be inserted thereinto. The inner first end of the body part 200 and the end of the head part 100 are formed at locations closest to each other. In other words, the inner first end of the body part 200 may contact the end of the head part 100 when the nozzle system is not spraying any fluid.

Thereafter, when fluid stored in the reservoir flows into the body part 200 in response to a user's request or a cleaning request of the sensor part 20, as shown in FIG. 3B, the head part 100 is configured to move in the longitudinal direction inside of the body part 200 along the protruding direction of the delay part 210.

According to a driving relationship shown in FIG. 3B, the spray part 140 of the head part 100 is moved along the longitudinal direction of the body part 200 so as to protrude outwards from the body part 200. According to a coupling relationship between the delay part 210 and the inside of the head part 100, fluid does not flow into the inside of the head part 100.

In other words, when the protruding length of the head part 100 is smaller than the length of the delay part 210, fluid flowing into the body part 200 does not move to the spray part 140 through the head part 100.

As shown in FIG. 3C, when the head part 100 clears the delay part 210, fluid located in the body part 200 is configured to flow along the inside of the head part 100 in an area where the end of the delay part 210 and the inflow part 120 located in the head part 100 face each other.

Furthermore, the head part 100 is moved in a direction further away from the end of the delay part 210. As a result, the sensing area of the sensor part 20 and the spray part 140 are configured to face each other.

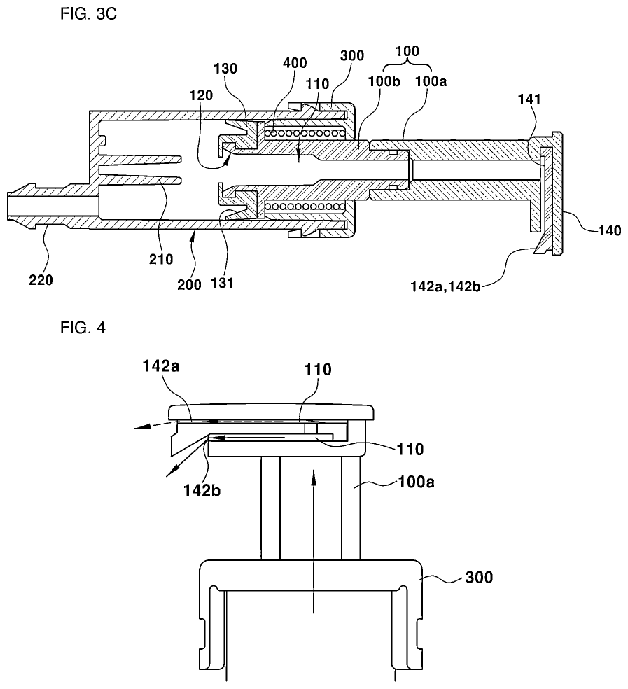

FIG. 4 is a diagram showing the configuration of the first discharge port 142a and the second discharge port 142b configured to have different spray angles according to the embodiment of the present disclosure.

As shown in FIG. 4, the spray part 140 includes the guide part 141, which is configured to allow fluid flowing in the longitudinal direction of the head part 100 to move in the latitudinal direction (e.g., widthwise direction) of the head part 100. The spray part 140 also includes at least one discharge port located at the end of the guide part 141 and is configured to spray fluid at a predetermined angle to the sensing area of the sensor part 20.

More particularly, the guide part 141 is configured to be in fluid communication with the first discharge port 142a and the second discharge port 142b, respectively. The first discharge port 142a and the second discharge port 142b may have different spray angles.

According to the embodiment of the present disclosure, the first discharge port 142a is formed at a relatively high location in the height direction of the head part 100, as shown in the drawings. The spray angle thereof is configured to have a relatively small angle based on the width direction of the head part 100.

On the other hand, the second discharge port 142b is formed at a location below the location of the first discharge port 142a in the height direction of the head part 100 in FIG. 4. The spray angle thereof is configured to have a relatively large angle based on the width direction of the head part 100.

Therefore, it is possible to provide the nozzle system 10 with the first discharge port 142a and the second discharge port 142b, each having different spray angles. This configuration makes it possible to clean a wide sensing area.

As is apparent from the above description, the present disclosure may obtain the following effects by a combination of the above-described configurations and usage relationship therebetween.

The present disclosure has an effect of providing a nozzle system configured to prevent fluid from being discharged when a head part is being moved along a body part and to spray the fluid to a target area to be cleaned.

In addition, the present disclosure has an effect of providing a nozzle system including a head part having discharge ports with different spray angles. As a result, the configuration makes it possible to clean sensor parts disposed at different locations.

The above detailed description is illustrative of the present disclosure. Furthermore, the above description is intended to describe embodiments of the present disclosure, and the present disclosure may be used in various other combinations, modifications, and environments. In other words, changes or modifications are possible within the scope of the concept of the disclosure disclosed in this specification, within the scope equivalent to the disclosed contents, and/or within the scope of those having ordinary skill or knowledge in the art. The above embodiments describe the best mode to implement the technical idea of the present disclosure, and various changes required in specific application fields and uses of the present disclosure are also possible. Therefore, the detailed description of the disclosure is not intended to limit the disclosure to the disclosed embodiments. Further, the appended claims should be construed as covering other embodiments as well.

What is claimed is:

1. A nozzle system comprising:
a head part including a spray part formed at a location corresponding to a sensor part;
a body part having a portion of the head part inserted thereinto and located therein, the body part having an inlet part configured to allow fluid to flow into the body part therethrough; and
a delay part configured to be inserted into at least the portion of the head part and located in the body part,
wherein the delay part protrudes in a movement direction of the head part,
wherein, when the fluid flows into the body part, the head part is configured to move along the delay part, and
wherein the fluid is sprayed out of the spray part of the head part when the head part is clear of an end of the delay part.

2. The nozzle system of claim 1, further comprising an elastic member located between the body part and the head part.

3. The nozzle system of claim 1, wherein the head part comprises:
a guide groove formed at a location facing the delay part;
an inflow part formed at one end of the guide groove, the one end facing the body part; and
a sealing part arranged to surround one end of the head part,
wherein the inflow part is configured to allow the fluid located in the body part to flow into the head part.

4. The nozzle system of claim 3, wherein the inflow part has a cross-section wider than a cross-section of the guide groove.

5. The nozzle system of claim 1, wherein the head part is configured to move by hydraulic pressure of the fluid flowing into the body part in a longitudinal direction thereof along an inside of the body part, and wherein the fluid located in the body part flows into the head part when the head part is moved to a location at which an inflow part faces and is clear of the end of the delay part.

6. The nozzle system of claim 1, wherein the body part further comprises a cover part formed at one end thereof, and wherein the head part is operated on a side of the one end of the body part.

7. The nozzle system of claim 1, wherein the spray part is located at an end of the head part and is configured to have a predetermined angle so as to allow the fluid flowing into the spray part to be sprayed to the sensor part.

8. The nozzle system of claim 1, wherein the spray part comprises:
a guide part configured to allow the fluid flowing into the head part to flow thereinto; and
a discharge port configured to discharge the fluid flowing into the guide part.

9. The nozzle system of claim 8, wherein the discharge port comprises:
a first discharge port formed at a first location in a height direction of the spray part; and
a second discharge port formed at a second location below the first location of the first discharge port.

10. The nozzle system of claim 9, wherein an angle formed by the first discharge port and a width direction of the head part is smaller than an angle formed by the second discharge port and the width direction of the head part.

11. A nozzle system comprising:
a head part disposed at a location corresponding to a sensor part;
a body part having a portion of the head part inserted thereinto and located therein, the body part including an inlet part configured to allow fluid to flow into the body part therethrough; and
a delay part configured to be inserted into at least the portion of the head part and located in the body part, wherein the delay part protrudes in a movement direction of the head part,
wherein, when the fluid flows into the body part, the head part is configured to move along the delay part, and
wherein the fluid is sprayed out of the head part when the head part is clear of an end of the delay part.

12. The nozzle system of claim 11, further comprising an elastic member located between the body part and the head part.

13. The nozzle system of claim 11, wherein the head part comprises:
a guide groove formed at a location facing the delay part;
an inflow part formed at one end of the guide groove, the one end facing the body part; and
a sealing part arranged to surround one end of the head part,
wherein the inflow part is configured to allow the fluid located in the body part to flow into the head part.

14. The nozzle system of claim 13, wherein the inflow part has a cross-section wider than a cross-section of the guide groove.

15. The nozzle system of claim 11, wherein the head part is configured to move by hydraulic pressure of the fluid flowing into the body part in a longitudinal direction thereof along an inside of the body part, and wherein the fluid located in the body part flows into the head part when the head part is move to a location at which an inflow part faces and is clear of the end of the delay part.

16. The nozzle system of claim 11, wherein the body part further comprises a cover part formed at one end thereof, and wherein the head part is operated on a side of the one end of the body part.

17. The nozzle system of claim 11, wherein the head part comprises a spray part formed at a location facing the sensor part.

18. The nozzle system of claim 17, wherein the spray part comprises:
a guide part configured to allow the fluid flowing into the head part to flow thereinto; and
a discharge port configured to discharge the fluid flowing into the guide part.

19. The nozzle system of claim 18, wherein the discharge port comprises:
a first discharge port formed at a first location in a height direction of the spray part; and
a second discharge port formed at a second location below the first location of the first discharge port.

20. The nozzle system of claim 19, wherein an angle formed by the first discharge port and a width direction of the head part is smaller than an angle formed by the second discharge port and the width direction of the head part.
